(19) United States
(12) Patent Application Publication
(10) Pub. No.: US 2022/0318822 A1
(43) Pub. Date: Oct. 6, 2022

(54) METHODS AND SYSTEMS FOR RIDESHARE IMPLICIT NEEDS AND EXPLICIT NEEDS PERSONALIZATION

(71) Applicant: Toyota Motor Engineering & Manufacturing North America, Inc., Plano, TX (US)

(72) Inventors: Rohit Gupta, Santa Clara, CA (US); Ziran Wang, San Jose, CA (US); Kyungtae Han, Palo Alto, CA (US); Prashant Tiwari, Santa Clara, CA (US)

(73) Assignee: Toyota Motor Engineering & Manufacturing North America, Inc., PLANO, TX (US)

(21) Appl. No.: 17/217,358

(22) Filed: Mar. 30, 2021

(51) Int. Cl. G06Q 30/02; G06Q 50/30; G06N 20/00; G06N 5/02

(52) U.S. Cl. CPC G06Q 30/0201; G06Q 30/0282; G06Q 50/30; G06N 20/00; G06N 5/02; B60R 11/04

(57) ABSTRACT

A method for rideshare personalization may include identifying one or more unmet needs among a set of needs of a user during a ride of a vehicle based on data from a sensor of the vehicle, updating a user profile of the user to include the one or more unmet needs in association with a set of contextual data related to the ride, and providing services associated with the one or more unmet needs to the user during another ride based on the updated user profile and the set of contextual data related to the another ride.

### TECHNICAL FIELD

The present disclosure relates to managing user profiles for vehicles and more particularly to methods and systems for rideshare personalization.

### BACKGROUND

Personalizing service for a user generally results in a higher level of user satisfaction with the service. For example, a user is likely to prefer one ride of a vehicle over another if the former ride plays music that the user enjoys and contains a charger appropriate for the user's devices but the latter ride does neither. Although many of details may be trivial in their implementation, they may result in a user preferring one rideshare service over another because there may be a feeling that the user is receiving more value out of the preferred rideshare service.

However, personalization may rely on the user taking the extra steps of providing preferences to each ridesharing service the user encounters. Even when preferences are provided, the preferences may not cover every scenario that the user may encounter with the ridesharing service. In such unaccounted for scenarios, the user must take even further steps to make specific requests to have the service personalized to the user's liking. Given all the extra effort the user must put forth to engage in basic personalization, many needs may be left unspoken or not even consciously considered. As a result, many needs may be left unmet by the time the user has completed engagement with the rideshare service.

Therefore, alternative methods for rideshare personalization are desired.

### SUMMARY

According to the subject matter of the present disclosure, a method includes identifying one or more unmet needs among a set of needs of a user during a ride of a vehicle based on data from a sensor of the vehicle, updating a user profile of the user to include the one or more unmet needs in association with a set of contextual data related to the ride, and providing services associated with the one or more unmet needs to the user during another ride based on the updated user profile and the set of contextual data related to the another ride.

In accordance with one embodiment of the present disclosure, a system includes one or more processors. The one or more processors may identify one or more unmet needs among a set of needs of a user during a ride of a vehicle based on data from a sensor of the vehicle, update a user profile of the user to include the one or more unmet needs in association with a set of contextual data related to the ride, and provide services associated with the one or more unmet needs to the user during another ride based on the updated user profile and the set of contextual data related to the another ride.

In accordance with another embodiment of the present disclosure, a non-transitory computer readable medium including machine-readable instructions may cause a processor to identify one or more unmet needs among a set of needs of a user during a ride of a vehicle based on data from a sensor of the vehicle, update a user profile of the user to include the one or more unmet needs in association with a set of contextual data related to the ride, and provide services associated with the one or more unmet needs to the user during another ride based on the updated user profile and the set of contextual data related to the another ride.

These and additional features provided by the embodiments of the present disclosure will be more fully understood in view of the following detailed description, in conjunction with the drawings.

### BRIEF DESCRIPTION OF THE DRAWINGS

The following detailed description of specific embodiments of the present disclosure can be best understood when read in conjunction with the following figures, where like structure is indicated with like reference numerals and in which:

FIG. 1 depicts a system for rideshare personalization, according to one or more embodiments shown and described herein;

FIG. 2 schematically depicts a vehicle and server computer, according to one or more embodiments shown and described herein;

FIG. 3 depicts a flowchart of a method for rideshare personalization, according to one or more embodiments shown and described herein;

FIG. 4 depicts a flowchart of a sequence prediction algorithm for identifying one or more unmet needs of a user, according to one or more embodiments shown and described herein;

FIG. 5 depicts a flowchart of a context sequence algorithm for identifying one or more unmet needs of a user, according to one or more embodiments shown and described herein;

FIG. 6 depicts a flowchart of a freshness algorithm for identifying one or more unmet needs of a user, according to one or more embodiments shown and described herein; and

FIG. 7 depicts a flowchart of a predictive algorithm for identifying one or more unmet needs of a user, according to one or more embodiments shown and described herein.

### DETAILED DESCRIPTION OF THE DRAWINGS

Embodiments of the present disclosure are aimed at identifying spoken needs and unspoken needs of a user to provide the user services to meet needs that have not already been met.

Needs that the user is consciously aware of may be spoken. For purposes of this disclosure, spoken needs are needs that may be expressed explicitly and/or verbally (i.e., by speech or by text) shared. Needs that are spoken may be more easily met because individuals or systems with the means to meet those needs may be made aware of them. For example, a user enters a preferred genre of music in the ridesharing mobile application to present a spoken need to the system that may be met on the user's next ride.

Needs that the user is consciously aware of may also be unspoken. For purposes of this disclosure, unspoken needs are needs that are not expressed explicitly and/or verbally. Because unspoken needs are not expressed explicitly and/or verbally, they may typically be unmet. However, needs that are unspoken may be expressed implicitly, and thus may still be met. Needs may be unspoken because the user may be uncomfortable divulging them. For example, a user may prefer a certain level of hygiene in a ride, but the user may not be comfortable divulging such a preference to the driver for fear of implying that the driver is unhygienic, yet such a preference may be implied by the user's facial expressions upon entering the ride.

Needs that the user is not consciously aware of are typically unspoken, and as thus are often unmet. For example, a user whose phone typically holds a charge for an entire day may not consciously consider whether to bring a charger for the phone to a ride. On the occasion the user does need to charge the phone, the ride may not have a charger, and thus that need may not be met.

Needs may be shared as preferences and/or requests. Preferences may be how the user would generally like specified needs to be met. Requests may be how the user would like specified needs to be met in a particular context.

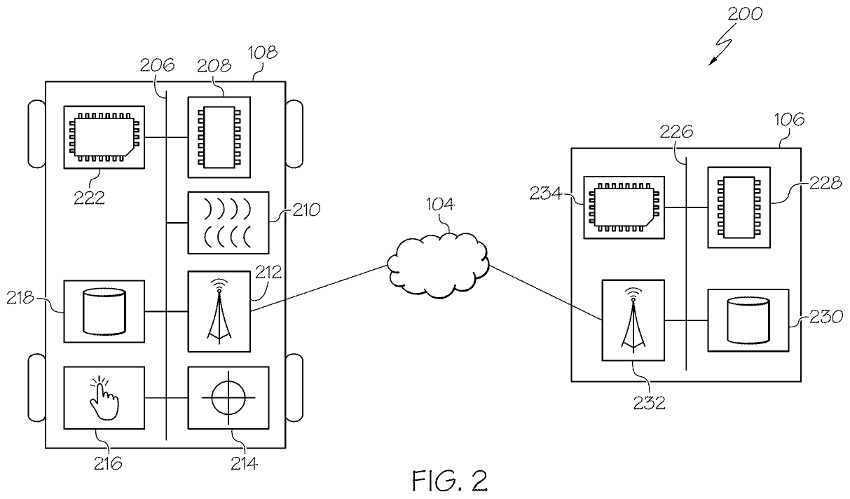

To identify unmet needs, vehicles may be equipped with sensors to identify data cues, as illustrated in FIG. 2. For example, vehicle sensors may include a camera to capture facial expressions and a microphone to capture voice expressions. Vehicle sensors may also retrieve user data stored in the user's personal device or a cloud-based server device. The user may provide spoken needs by explicitly entering the preference and/or request as appropriate on the user's device. Unspoken needs may be identified based on data collected from the vehicle's sensors and from previous rides of the user.

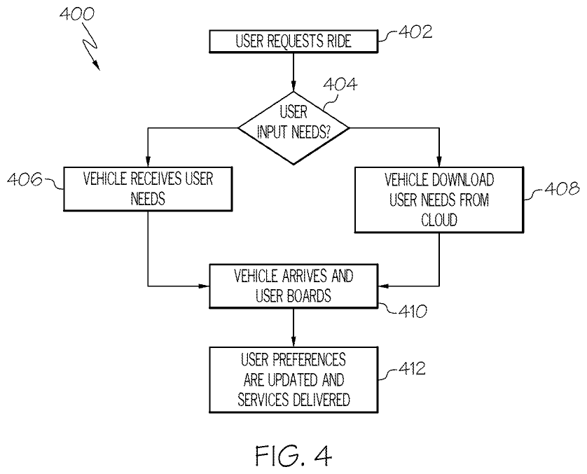

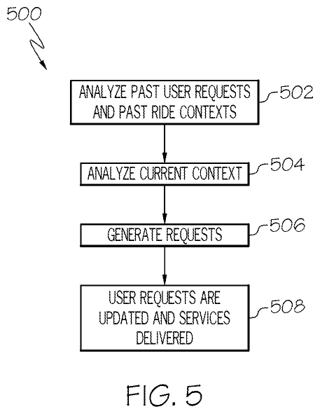

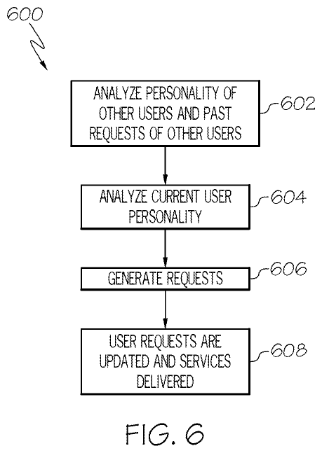

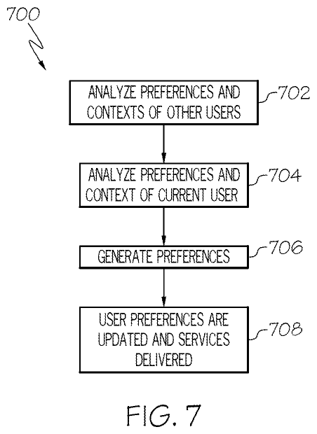

The data gathered by the system may in turn be used to train a variety of machine learning models to further identify unmet needs of the user. Machine learning models include a sequence prediction machine learning model to anticipate the user's preferences, as illustrated in FIG. 4, and a context sequence machine learning model to anticipate the user's requests, as illustrated in FIG. 5. The system may also include machine learning models that leverage the technique of collaborative filtering. Machine learning models also include a freshness machine learning model to recommend requests that the user may like based on similar users, as illustrated in FIG. 6, and a prediction model to recommend preferences that the user may like based on similar users, as illustrated in FIG. 7.

Accordingly, disclosed herein are methods and systems for rideshare “implicit subconscious” and “explicit conscious” personalization.

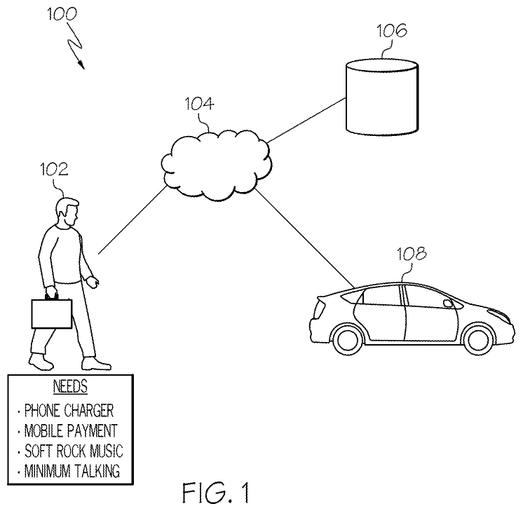

Referring now to FIG. 1, an example system for rideshare personalization is depicted. A system 100 includes a user 102, a network 104, a server 106, and a vehicle 108. The user 102 may have a personal device that may be communicatively coupled to the server 106 and/or the vehicle 108 via network 104. The server 106 and the vehicle 108 may be communicatively coupled to each other via network 104. In FIG. 1, only a single user, server, and vehicle are shown; however, it should be understood that any number of users, servers, and vehicles may be included.

The user 102 may be an individual. The user 102 may be attempting to request a ride from a rideshare program and may have a personal device to request a ride. The personal device may include a smartphone, a tablet, a laptop, and the like. For newer customers, the system 100 may rely more heavily on preferences that the user 102 has spoken via an application on the user's personal device to personalize a ride, as the system 100 may not have acquired enough data to train the machine learning models discussed above and to be discussed in more detail below.

The vehicle 108 may be part of a rideshare program and requested by the user 102. The vehicle 108 may be manually driven or autonomously driven. The vehicle 108 may be an automobile or any other vehicle such as, e.g., a terrestrial, aquatic, and/or airborne vehicle. The vehicle 108 may contain one or more software applications and one or more radios to communicate with the server 106. The software applications and radios may be on a device present in the vehicle, such as a smartphone, or embedded in the vehicle 108. When the user 102 requests a ride from the system 100, the vehicle 108 may receive directions to the user's pickup location and/or directions to the user's drop-off location. Before the user 102 enters the vehicle 108, the vehicle 108 and/or the vehicle's driver may also receive the user's preferences and/or requests from the system 100. The vehicle 108 may also be selected by the system 100 because the vehicle 108 has capabilities that would meet the needs of the user 102 as expressed by the user's preferences and/or requests. For example, if the user 102 indicates a preference for vehicles with a device charger, the system 100 may selected the vehicle 108 over other vehicles that may be closer to the user 102 because the vehicle 108 has a charger and thus can meet a need of the user 102.

Managing the fleet of rideshare vehicles is the server 106. The server 106 may be positioned remotely from the area in which the user 102 and/or the vehicle 108 is located. The server 106 may be a cloud-based device or may be some other computing device. The server 106 may store a user profile including the user's preferences, requests, ride history, and other user data. The server 106 may also perform machine learning functions on its stored user data. For example, the server 106 may train machine learning models to improve its services to the user 102. The server 106 may also store vehicle information, such as location and capabilities, to select an appropriate vehicle for a requested ride and to provide the vehicle's location to the requester, for instance. The server 106 may also receive and process data from sensors of the vehicle 108. For example, the server 106 may apply a natural language processing (NLP) process on a voice data captured from a vehicle sensor and sent to the server 106.

Referring now to FIG. 2, the example vehicle 108 and the example server 106 are schematically depicted. The vehicle 108 may include a processor component 222, a memory component 208, a sensor 210, a network connectivity component 212, a satellite component 214, an interface 216, and a data storage component 218. The vehicle 108 may also include a communication path 206 that communicatively connects the various components of the vehicle 108.

The processor component 222 may include one or more processors that may be any device capable of executing machine-readable and executable instructions. Accordingly, each of the one or more processors of the processor component 222 may be a controller, an integrated circuit, a microchip, or any other computing device. The processor component 222 is communicatively coupled to the communication path 206 that provides signal connectivity between the various components of the vehicle. Accordingly, the communication path 206 may communicatively couple any number of processors of the processor component 222 with one another and allow them to operate in a distributed computing environment. Specifically, each processor may operate as a node that may send and/or receive data. As used herein, the phrase “communicatively coupled” or “communicatively connected” means that the components referred to are capable of exchanging data signals with one another such as, e.g., electrical signals via a conductive medium, electromagnetic signals via air, optical signals via optical waveguides, and the like.

The communication path 206 may be formed from any medium that is capable of transmitting a signal such as, e.g., conductive wires, conductive traces, optical waveguides, and the like. In some embodiments, the communication path 206 may facilitate the transmission of wireless signals, such as Wi-Fi, Bluetooth®, Near-Field Communication (NFC), and the like. Moreover, the communication path 206 may be formed from a combination of mediums capable of transmitting signals. In one embodiment, the communication path 206 comprises a combination of conductive traces, conductive wires, connectors, and buses that cooperate to permit the transmission of electrical data signals to components such as processors, memories, sensors, input devices, output devices, and communication devices. Accordingly, the communication path 206 may comprise a vehicle bus, such as for example a LIN bus, a CAN bus, a VAN bus, and the like. Additionally, it is noted that the term “signal” means a waveform (e.g., electrical, optical, magnetic, mechanical, or electromagnetic), such as DC, AC, sinusoidal-wave, triangular-wave, square-wave, vibration, and the like, capable of traveling through a medium.

The memory component 208 is communicatively coupled to the communication path 206 and may contain one or more memory modules comprising RAM, ROM, flash memories, hard drives, or any device capable of storing machine-readable and executable instructions such that the machine-readable and executable instructions can be accessed by the processor component 222. The machine-readable and executable instructions may comprise logic or algorithms written in any programming language of any generation (e.g., 1GL, 2GL, 3GL, 4GL, or 5GL) such as, e.g., machine language, that may be directly executed by the processor, or assembly language, object-oriented languages, scripting languages, microcode, and the like, that may be compiled or assembled into machine-readable and executable instructions and stored on the memory component 208. Alternatively, the machine-readable and executable instructions may be written in a hardware description language (HDL), such as logic implemented via either a field-programmable gate array (FPGA) configuration or an application-specific integrated circuit (ASIC), or their equivalents. Accordingly, the methods described herein may be implemented in any conventional computer programming language, as pre-programmed hardware elements, or as a combination of hardware and software components. The memory component 208 may include various algorithms for identifying unmet needs of a user. The various algorithms may include a sequence prediction algorithm, a context sequence algorithm, a freshness algorithm, and a predictive algorithm, which will be described in detail below with reference to FIGS. 4 through 7.

The sensor 210 is communicatively coupled to the communication path 206 and may include, e.g., LiDAR sensors, RADAR sensors, optical sensors (e.g., cameras), laser sensors, proximity sensors, location sensors, audio sensors, and the like. In embodiments, the sensor 210 may monitor the surroundings of the vehicle and may detect other vehicles and/or traffic infrastructure. In embodiments, the sensor 210 may receive user data from a user and/or a server 106.

The network connectivity component 212 is communicatively coupled to the communication path 206 and includes network connectivity hardware for communicatively coupling the vehicle 108 to the server 106 via the network 104. The network connectivity component 212 can be communicatively coupled to the communication path 206 and can be any device capable of transmitting and/or receiving data via a network or other communication mechanisms. Accordingly, the network connectivity component 212 can include a communication transceiver for sending and/or receiving any wired or wireless communication. For example, the network connectivity hardware of the network connectivity component 212 may include an antenna, a modem, an Ethernet port, a Wi-Fi card, a WiMAX card, a cellular modem, near-field communication hardware, satellite communication hardware, and/or any other wired or wireless hardware for communicating with other networks and/or devices.

A satellite component 214 is communicatively coupled to the communication path 206 such that the communication path 206 communicatively couples the satellite component 214 to other modules of the vehicle 108. The satellite component 214 may comprise one or more antennas configured to receive signals from global positioning system (GPS) satellites. Specifically, in one embodiment, the satellite component 214 includes one or more conductive elements that interact with electromagnetic signals transmitted by GPS satellites. The received signal is transformed into a data signal indicative of the location (e.g., latitude and longitude) of the satellite component 214, and consequently, the vehicle 108. The satellite component 214 may be included in the sensor 210.

The data storage component 218 is communicatively coupled to the communication path 206 and may store data used by various components and applications of the vehicle 108. The data storage component 218 may be included in the memory component 208, and vice versa. In addition, the data storage component 218 may store data gathered by the sensor 210, received from the server 106, and/or received from a user. The data storage component 218 may be a cache for ride data to the server 106 and the user.

The interface 216 is communicatively coupled to the communication path 206. The interface 216 may allow for data to be presented to a driver and/or passenger and for data to be received from a driver and/or passenger. For example, the interface 216 may include a screen to display information, speakers to present audio information, and a touch screen that may be used to input information, and other types of interfaces. The interface 216 may output information received from the server 106. For example, the interface 216 may display a navigational route generated by the server 106. The interface 216 may be included in the sensor 210.

In some embodiments, the vehicle 108 may be communicatively coupled to the server 106 by a network 104. The network 104 may be a wide area network, a local area network, a personal area network, a cellular network, a satellite network, and the like.

The server 106 may include a processor component 234, a memory component 228, a network connectivity component 232, a data storage component 230, and a communication path 226. Each server component is similar in structure and features to its vehicle counterpart, described in detail above. Similar to memory component 208, the memory component 228 may include various algorithms for identifying unmet needs of a user including the sequence prediction algorithm, the context sequence algorithm, the freshness algorithm, and the predictive algorithm.

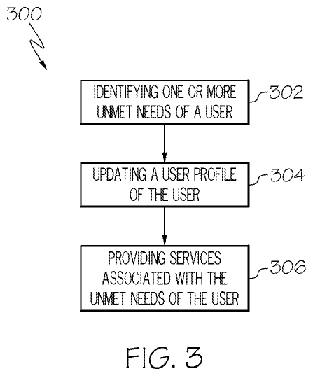

Referring now to FIG. 3, a flowchart of an example method for rideshare personalization is depicted. The method 300 is described by referring to FIG. 1 and FIG. 2 above. Embodiments of the method described herein are not limited to the steps included in FIG. 3 nor are they limited to the order as shown in FIG. 3.

At step 302, a set of unmet needs of a user are identified. Needs may be characterized as a set of requirements for a ride and may be expressed as preferences and/or requests. Some needs may be more critical than others. Some needs may also be easier to identify. A set of needs of a user may include, but are not limited to, arrival time, type of vehicle, temperature, internet connectivity, a device charger, a level of talking, a volume and/or genre of music, a type of navigational route, a payment method, etc.

Explicit, or spoken, needs may be identified by the user inputting them into the rideshare system 100. For example, a user may input a preference and/or request into the system 100 by filling out a survey on an interface 216. Preferences and/or requests may also be input into the system 100 by a driver. For example, a user 102 may request the temperature be increased during a ride, and the driver may enter the request into the system 100 afterwards via an interface 216. Preferences and/or requests may also be input into the system 100 by a vehicle 108. For example, the user 102 may request the volume of the music be increased during a ride, and the vehicle 108 may enter the request into the system 100 afterward based on a sensor 210 detecting the increase in music volume. In some embodiments, temperature or volume setting information along with the identification of the user 102 may be transmitted to the server 106 during or after the ride without the driver's manual input. The server 106 may update the profile for the user 102 based on the received temperature or volume setting information and the identification.

Implicit, or unspoken, needs may also be identified from preferences of previous rides of the user 102. As a user 102 accumulates rideshare mileage, the system 100 may collect and analyze user preferences over time to train a sequence prediction machine learning model. The sequence prediction machine learning model may receive data from the sensor 210 during a current ride and use it to generate a preference and/or request to share with the user 102.

For example, the temperature preference of the user 102 may indicate a preferred temperature of 70° F. However, the system 100, by a sequence prediction machine learning model, may notice that the user 102 changes the temperature preference to 68° F. when the outside weather is above 75° F., based on sensors 210 that detect temperature. The system 100 (e.g., via the user's personal device or the vehicle 108) may ask the user 102 whether the user 102 would like to change the temperature preference, when the outside weather climbs above 75° F. to meet a potential temperature need that is currently unmet.

As another example, a sensor 210 in a vehicle 108 that detects sound (e.g., a microphone) may receive the speech data of the user 102 and process the speech data with an NLP tool to extract keywords (e.g., warm, cool, loud, soft, etc.) and/or phrases (e.g., “I wish,” “if only,” “what if,” etc.) signaling an implicit need. The user 102 may be on a phone call complaining about the vehicle 108 being too small. The system 100 may capture that speech data with a sensor 210 and apply a sequence prediction machine learning model to determine that the user 102 has indicated a preference for larger vehicles to meet a potential comfort need that is currently unmet.

Implicit needs may also be identified based on contexts from previous rides of the user 102. As a user 102 accumulates rideshare mileage, the system 100 may collect and analyze contexts over time to train a contextual sequence machine learning model. The context data may be gathered from the sensors 210 and may include time, date, weather, location, condition of the user 102, and other data that may be collected from sensors 210. The contextual sequence machine learning model may receive context data from the sensor 210 during a current ride and use it to generate a request to share with the user 102.

For example, the temperature preference of the user 102 may indicate a preferred temperature of 70° F. However, the system 100, by a contextual sequence machine learning model, may notice that the user 102 has been requesting a temperature of 68° F. when the outside weather is above 75° F., based on sensors 210 that detect temperature. The system 100 (e.g., via the user's personal device or the vehicle 108) may ask the user 102 whether the user 102 would like to make a request to the driver to change the temperature for the current ride to meet a potential comfort need that is currently unmet.

As another example, a satellite component 214 may determine that the user 102 is being picked up at an airport and that it is past midnight at that location. The system 100, by a contextual sequence machine learning model, may determine that a user 102 is fatigued based on contextual information from the satellite component 214 and other sensors 210 (e.g., a sensors captures the sound of the user 102 yawning) and may automatically request to the driver to keep talking to a minimum because the user has made requests to keep talking to a minimum under similar contexts in the past to meet a potential comfort need that is currently unmet.

Implicit needs may also be identified based on requests from previous rides of a plurality of users. As a plurality of users accumulate rideshare mileage, the system 100 may collect and analyze requests of a plurality of users over time to train a freshness machine learning model. The freshness machine learning model may be based on a collaborative filtering technique and may be used to recommend requests that may be new and/or unfamiliar to a user 102 to keep the user's experience with the system 100 fresh. The freshness machine learning model may receive data from sensors 210 during a current ride and use the data to generate a set of requests to share with the user 102.

For example, a set of requests of a plurality of users and a set of contextual data of the plurality of users may indicate that users who prefer larger vehicles and rock music also tend to request mobile payments. If a user 102 has indicated a preference for larger vehicles and sensors 210 detect rock music, the system may recommend that the user 102 make a request for a mobile payment for the current ride to meet a potential payment need that is currently unmet. In some embodiments, the system may identify as an implicit need of the user that the user 102 prefers a mobile payment for the current ride if the user 102 has indicated a preference for larger vehicles and sensors 210 detect rock music, and update the profile for the user 102 to include the implicit need.

As another example, because contextual data may include user personality data (e.g., a user's motion or facial expressions may indicate a level of extroversion), a set of requests of a plurality of users and a set of contextual data of the plurality of users may indicate that users who prefer windows down and have a particular posture indicative of a fear of enclosed spaces also tend to request larger vehicles with a sunroof. If a user 102 prefers windows down and sensors 210 detect a posture indicative of a fear of enclosed spaces, the system may recommend the user 102 make a request for a large vehicle with a sunroof to meet a potential comfort need that is currently unmet. In some embodiments, the system 100 may identify as an implicit need of the user that the user 102 prefers larger vehicles with a sunroof if the user 102 prefers windows down and sensors 210 detect a posture indicative of a fear of enclosed spaces, and update the profile for the user 102 to include the implicit need.

Implicit needs may also be identified based on preferences of a plurality of users and a set of contextual data of a plurality of users. As a plurality of users accumulate rideshare mileage, the system 100 may collect and analyze preferences and contexts of a plurality of users over time to train a predictive machine learning model. The predictive machine learning model may be based on a collaborative filtering technique and may be used to recommend preferences that may be undetermined by a user 102 to further personalize the user's experience with the system 100. The predictive machine learning model may receive data from sensors 210 during a current ride and use the data to generate a set of preferences to share with the user 102.

For example, a set of preferences of a plurality of users and a set of contextual data of the plurality of users may indicate that users who prefer smaller vehicles and hip-hop music also tend to prefer paying by credit card. If a user 102 has indicated a preference of smaller vehicles and is listening to hip-hop music on the current ride, the system may recommend that the user 102 set a payment preference to credit cards to meet a potential payment need that is currently unmet.

As another example, because contextual data may include user personality data, a set of preferences of a plurality of users and a set of contextual data of the plurality of users may indicate that users who prefer no music and exhibit an extroverted personality also tend to prefer a more conversational driver. If a user 102 has indicated a preference of no music and the system 100 determines that the user 102 has an extroverted personality based on a boisterous phone conversation detected from a sensor 210 in the current ride, the system 100 may recommend that the user 102 set a preference for a conversational driver to meet a potential conversation need that is currently unmet.

It should be understood that the system 100 may analyze any number of preferences, requests, contexts, and sensors to recommend any number of preferences and requests to the user 102 as appropriate.

Still referring to FIG. 3, at step 304, the system 100 updates a user profile of the user 102. The user profile may be updated to include the identified needs of the user 102 from step 302 and may also be updated to the contextual data of the ride.

The user profile may be updated to include the identified needs of the user 102 that are unmet. A need may be determined to be unmet if the need could not be recommended, measures to meet the need could not be implemented, and/or the need was otherwise left unfulfilled. Needs that are met at one point in time may become unmet at another. The contextual data of the ride may be any data relating to the conditions surrounding the ride (e.g., time, location, vehicle, duration, driver personality, user preferences, user requests, etc.), including any data gathered by sensors 210.

The user profile may be stored on the server 106. The user profile may be used for analysis to identify needs of the user 102 to which the profile relates. The user profile may also be used for analysis to identify needs of other users to which the profile does not relate, for participating in collaborative filtering in a machine learning model. The user profile may be used by the system 100 at any point before, during, or after a ride.

At step 306, the system 100 may provide services associated with the unmet needs of the user 102. The server 106 may determine what services are available before the ride to determine what vehicle to send to the user 102. For example, if the user profile of the user 102 indicates a preference for sedans, the system 100 may narrow the search for nearby vehicles to vehicles that are sedans. The server 106 and/or the vehicle 108 may determine what services are available during the ride to meet needs that may arise during the ride. For example, if a user requests the volume of the music to be lowered, the server 106 may pass the request on to the driver of the vehicle 108.

Referring now to FIG. 4, a flowchart of a sequence prediction algorithm for identifying one or more unmet needs of a user is depicted. The sequence prediction algorithm 400 is described by referring to FIG. 1 and FIG. 2 above. Embodiments of the algorithm 400 described herein are not limited to the steps included in FIG. 4 nor are they limited to the order as shown in FIG. 4.

At step 402, the user 102 requests a ride. The request may be made through a network connected device that communicates the request to the server 106. The server 106 may verify the user account, verify payment information, confirm authorization to request a ride, locate a vehicle, among other logistical tasks.

At step 404, it is determined whether the user 102 has input new preferences and/or requests, reflecting new needs. If the user 102 has input new preferences and/or requests, the algorithm moves to step 406; if not, the algorithm moves to step 408.

At step 406, the vehicle 108 may receive the new needs from the user 102. Once the vehicle 108 receives the new needs from the user 102, the vehicle 108 may begin preparing the necessary services to potentially meet the new needs. The server 106 may also receive the new needs from the user 102 and pass them along to the vehicle 108. The server 106 receiving the new needs first would enable the server 106 to select a vehicle to perform the ride that may meet at least one of the new needs.

At step 408, the vehicle 108 may download the user needs from the server 106. Once the vehicle 108 receives the new needs from the system 100, the vehicle 108 may begin preparing the necessary services to potentially meet the new needs. Before the download, the system 100 may use the user profile to train a sequence prediction machine learning model. The sequence prediction machine learning model may receive a set of preferences of the user 102 for training. The trained sequence prediction machine learning model may receive as inputs a set of data for the sensors 210 of the vehicle. The trained sequence prediction machine learning model may generate as outputs a recommended set of preferences.

For example, a sequence prediction machine learning model is trained on a set of preferences of the user, wherein the preferences indicate that the user prefers holiday music during the holiday season and otherwise prefers jazz music. The sequence prediction machine learning model receives data from sensors 210 of a previous ride of the user that indicates that the date is now within the holiday season. Accordingly, the sequence prediction machine learning model recommends an updated preference of holiday music.

It should be understood that the system 100 does not require the user 102 do input preferences and/or requests. The system 100 may rely on sensors 210 to determine implicit needs of the user 102. Additionally, the vehicle 108 may cache the user profile for future rides with the user, in which case the vehicle 108 would not need to re-download the user profile unless the user profile has since been modified.

At step 410, the vehicle 108 arrives at the user's location and the user 102 boards the vehicle 108. At this point, the vehicle 108 may be prepared to meet the user's needs and/or determine further needs.

At step 412, the user's preferences are updated in the user profile and services may be delivered to meet the user's needs, including the new preferences.

Before the needs are updated in the user profile, the system 100 may present to the user 102 the recommended preferences from the trained sequence prediction machine learning model, as described in step 408. The user 102 may manually or automatically approve some or all of the recommended preferences.

New needs (e.g., preferences entered by the user 102, preferences recommended to and approved by the user 102, or both) may be applied to rides after entered or approved by the user. New needs may also be uploaded to the server 106 to update the user profile. Uploading new needs to the server 106 may allow the system 100 to further train the sequence prediction machine learning model and may allow future vehicles to have access to the most recent version of the user profile.

The system 100 may also solicit feedback from the user 102. The solicitation of feedback may be in any form that may be received by a sensor 210 (e.g., a touch sensor on the user interface 216). The feedback may be implied from the choice of the user 102 to approve or deny recommended preferences, from the user's tone of voice, among other indicators of feedback. The feedback may also be uploaded to the server 106 to further train the sequence prediction machine learning model for more accurate preference prediction.

Referring now to FIG. 5, a flowchart of a context sequence algorithm for identifying one or more unmet needs of a user is depicted. The context sequence algorithm 500 is described by referring to FIG. 1 and FIG. 2 above. Embodiments of the algorithm 500 described herein are not limited to the steps included in FIG. 5 nor are they limited to the order as shown in FIG. 5.

At step 502, the system 100 may analyze past user requests along with corresponding past ride contexts to train a contextual sequence machine learning model. The contextual sequence model aims to forecast user requests based on a current context according to patterns found in past user requests. The contextual sequence model receives a set of past requests of the user and a set of past request context data for training.

At step 504, the system 100 may analyze a current context. The current context may be based on any data (e.g., time, location, temperature, user behavior, etc.) received from any sensor 210 of a vehicle 108. In its analysis, the context sequence machine learning model may utilize the current context to find sets of similar contexts.

At step 506, the system 100 may generate requests. The sets of similar contexts found by the context sequence machine learning model in step 504 may indicate that past requests corresponding to the similar contexts may be appropriate for the current context. The context sequence machine learning model may generate requests similar to past requests made under similar contexts.

For example, if the user 102 routinely requests that the windows be rolled down when sensors 210 indicate that the weather is warm and sunny, then the contextual sequence model may recommend requesting the windows to be rolled down when the context indicates that it is warm and sunny.

At step 508, the requests of the user 102 are updated in the user profile and services may be delivered to meet the user's needs, including the new requests.

Before the requests are updated in the user profile, the system 100 may present the recommended requests from the trained contextual sequence model, as described in step 506. The user 102 may manually or automatically approve some or all of the recommended requests.

New needs (e.g., requests entered by the user 102, requests recommended to and approved by the user 102, or both) may be applied to rides after entered or approved by the user 102. New needs may also be uploaded to the server 106 to update the user profile. Uploading new needs to the server 106 may allow the system 100 to further train the contextual sequence model and may allow future vehicles to have access to the most recent version of a user profile.

The system 100 may also solicit feedback from the user 102. The solicitation of feedback may be in any form that may be received by a sensor 210 (e.g., a touch sensor on the interface 216). The feedback may be implied from the choice of the user 102 to approve or deny recommended preferences, from the user's tone of voice, among other indicators of feedback. The feedback may also be uploaded to the server 106 to further train the contextual sequence model for more accurate request predictions.

Referring now to FIG. 6, a flowchart of a freshness algorithm for identifying one or more unmet needs of a user is depicted. The freshness algorithm 600 is described by referring to FIG. 1 and FIG. 2, above. Embodiments of the algorithm 600 described herein are not limited to the steps included in FIG. 6 nor are they limited to the order as shown in FIG. 6.

At step 602, the algorithm 600 may analyze the personality of other users along with the corresponding past requests of the other users to train a freshness machine learning model. Personality may be explicitly determined from a user (e.g., via surveys). Personality may also be inferred from voice data, face data, movement data, and other user expression data. The freshness machine learning model aims to recommend requests to a user based on the user's personality that may be new to the user. The analysis that freshness machine learning model engages in is based on a collaborative filtering technique, unlike the sequence prediction machine learning model and the contextual sequence model. For example, the algorithm 600 may find other users with similar personalities as the user 102 and combine the context data, preferences, and/or requests with the context data, preferences, and/or requests of the user 102 to create a larger dataset from which the algorithm 600 may generate requests.

At step 604, the algorithm 600 may analyze the personality of the user 102. The personality of the user may also be explicitly determined and/or inferred. The personality of the user 102 may be used as an input for the trained freshness machine learning model. The trained freshness machine learning model may narrow down the data of other users to data of other users having a similar personality as the user 102.

At step 606, the algorithm 600 may generate a recommended set of requests to the user 102. The recommended set of requests may be based on the data of other users having a similar personality as the user 102. The data of other users having a similar personality as the user 102 may supplement data of the user 102 for the freshness machine learning model to find requests that may be of interest to the user 102. The recommendations output by the model may otherwise not have been recommended to the user 102 because the system 100 did not have enough data about the user 102, the user 102 does not tend to deviate from a routine set of preferences and/or requests, among other reasons. Because of the larger dataset from the other users and because the recommendations are based on other users having a similar personality as the user 102, the recommendations are more likely to be accepted by the user 102 and provide the user 102 a fresher experience with the system 100.

For example, a set of other users of the system 100 may exhibit a significant degree of savviness with technology (e.g., based on context data, requests, preferences, etc.), and the set of other users may request and/or prefer more technologically cutting-edge experiences (e.g., a self-driving vehicle). If the user 102 indicates a similar degree of savviness with technology, the system 100 may recommend to the user 102 services representative of more technology cutting-edge experiences (e.g., a self-driving vehicle) to keep the user's experience with the system 100 fresh.

At step 608, the user's requests are updated in the user profile and services may be delivered to meet the user's needs, including the new requests.

Before the requests are updated in the user profile, the system 100 may present the recommended requests from the trained freshness machine learning model, as described in step 606. The user 102 may manually or automatically approve some or all of the recommended requests.

New needs (e.g., requests entered by the user 102, requests recommended to and approved by the user 102, or both) may be applied to rides after entered or approved by the user 102. New needs may also be uploaded to the server 106 to update the user profile. Uploading new needs to the server 106 may allow the system 100 to further train the freshness machine learning model for the user 102, as well as other users, and may allow future vehicles to have access to the most recent version of a user profile.

The algorithm 600 may also solicit feedback from the user 102. The solicitation of feedback may be in any form that may be received by a sensor 210 (e.g., a touch sensor on the interface 216). The feedback may be implied from the choice of the user 102 to approve or deny recommended preferences, from the user's tone of voice, among other indicators of feedback. The feedback may also be uploaded to the server 106 to further train the freshness machine learning model for more accurate request predictions for the user 102 as well as other users.

Referring now to FIG. 7, a flowchart of a predictive algorithm for identifying one or more unmet needs of a user is depicted. The predictive algorithm 700 is described by referring to FIG. 1 and FIG. 2, above. Embodiments of the algorithm 700 described herein are not limited to the steps included in FIG. 7 nor are they limited to the order as shown in FIG. 7.

At step 702, the algorithm 700 may analyze the preference data and the context data of other users to train a predictive machine learning model. Preference data may include a user's preferences over time. Context data may include the context associated with a user's rides over time. The predictive machine learning model aims to recommend preferences to a user by leveraging similarity between users and their reactions to different contexts. The analysis of the predictive machine learning model, like the freshness machine learning model, engages in a collaborative filtering technique. For example, the algorithm 700 may find other users with similar preference and under similar contexts and combines the similar preferences and similar contexts with the preference and context data of the user to create a larger dataset from which the algorithm 700 may generate preferences.

At step 704, the algorithm 700 may analyze the preferences and contexts of the user 102. The preferences and contexts of the user 102 may be used as inputs to the trained predictive machine learning model. The trained predictive machine learning model may narrow down the data of the other users to data of the other users having similar preferences under similar conditions as the user 102.

At step 706, the algorithm 700 may generate a recommended set of preferences to the user 102. The recommended set of preferences may be based on the data of other users having similar preferences under similar contexts as the user. The data of other users having a similar set of preferences under similar contexts of the user 102 may supplement data of the user for the predictive machine learning model to find preferences that may be of interest to the user 102. The recommendations output by the model may not have otherwise been recommended to the user 102 because the system 100 did not have enough data about the user 102, the user 102 does not tend to deviate from a routine set of preferences, among other reasons. Because of the larger dataset from the other users and because the recommendations are based on other users having similar preferences as the user 102 under similar contexts, the recommendations are more likely to be accepted by the user 102 and provide the user 102 a more accommodating experience because it may develop more accurate preference predictions as the user 102 continues to engage with the system 100.

At step 708, the user's requests are updated in the user profile and services may be delivered to meet the user's needs, including the new preferences.

Before the preferences are updated in the user profile, the system 100 may present to the user 102 the recommended preferences from the trained predictive machine learning model, as described in step 706. The user 102 may manually or automatically approve some or all of the recommended preferences.

New needs (e.g., preferences entered by the user 102, preferences recommended to and approved by the user 102, or both) may be applied to rides after entered or approved by the user. New needs may also be uploaded to the server 106 to update the user profile. Uploading new needs to the server 106 may allow the system 100 to further train the predictive machine learning model for the user 102, as well as other users, and may allow future vehicles to have access to the most recent version of a user profile.

The algorithm 700 may also solicit feedback from the user 102. The solicitation of feedback may be in any form that may be received by a sensor 210 (e.g., a touch sensor on the interface 216). The feedback may be implied from the choice of the user 102 to approve or deny recommended preferences, from the user's tone of voice, among other indicators of feedback. The feedback may also be uploaded to the server 106 to further train the predictive machine learning model for more accurate preference predictions for the user 102 as well as other users.

It should now be understood that disclosed herein are embodiments directed to methods and systems for rideshare personalization that targets implicit and/or explicit needs of a user. Embodiments identify unspoken (i.e., implicit) and/or spoken (i.e., explicit) needs of a user to provide the user services to meet needs that have not already been met. Vehicles may be equipped with sensors to identify unspoken needs as well as anticipate future needs of a user by using sensor data as inputs to various algorithms, each utilizing machine learning models.

The present disclosure proposes four algorithms and corresponding machine learning models, two of which recommend preferences (i.e., how a user would generally like a specified need to be met) and two of which recommend requests (i.e., how a user would like a specified need to be met in a particular context). Of each group, one algorithm may be based on the data of the user (i.e., the sequence prediction algorithm and the contextual sequence algorithm) while the other algorithm may be based on the data of a broad set of users in a collaborative filtering technique (i.e., the freshness algorithm and the predictive algorithm).

Any combination of the proposed algorithms may be used to identify one or more unmet needs of a user. Once the unmet needs are identified, the user profile of the user is updated so that the services associated with the unmet needs of the user may be provide in subsequent rides.

It is noted that recitations herein of “at least one” component, element, etc., should not be used to create an inference that the alternative use of the articles “a” or “an” should be limited to a single component, element, etc.

It is noted that recitations herein of a component of the present disclosure being “configured” or “programmed” in a particular way, to embody a particular property, or to function in a particular manner, are structural recitations, as opposed to recitations of intended use. More specifically, the references herein to the manner in which a component is “configured” or “programmed” denotes an existing physical condition of the component and, as such, is to be taken as a definite recitation of the structural characteristics of the component.

It is noted that terms like “preferably,” “commonly,” or “typically,” when utilized herein, are not utilized to limit the scope of the claimed invention or to imply that certain features are critical, essential, or even important to the structure or function of the claimed invention. Rather, these terms are merely intended to identify particular aspects of an embodiment of the present disclosure or to emphasize alternative or additional features that may or may not be utilized in a particular embodiment of the present disclosure.

Having described the subject matter of the present disclosure in detail and by reference to specific embodiments thereof, it is noted that the various details disclosed herein should not be taken to imply that these details relate to elements that are essential components of the various embodiments described herein, even in cases where a particular element is illustrated in each of the drawings that accompany the present description. Further, it will be apparent that modifications and variations are possible without departing from the scope of the present disclosure, including, but not limited to, embodiments defined in the appended claims. More specifically, although some aspects of the present disclosure are identified herein as preferred or particularly advantageous, it is contemplated that the present disclosure is not necessarily limited to these aspects.

What is claimed is:

1. A method comprising:
identifying one or more unmet needs among a set of needs of a user during a ride of a vehicle based on data from a sensor of the vehicle;
updating a user profile of the user to include the one or more unmet needs in association with a set of contextual data related to the ride; and
providing services associated with the one or more unmet needs to the user during another ride based on the updated user profile and the set of contextual data related to the another ride.

2. The method of claim 1, wherein:
the sensor of the vehicle comprises at least one of a microphone, a camera, a motion sensor, and a location sensor; and
the data from the sensor comprises at least one of voice data, face data, movement data, and location data.

3. The method of claim 1, wherein identifying one or more unmet needs among the set of needs comprises:
training a sequence prediction machine learning model on a set of preferences of the user;
receiving, as inputs to the sequence prediction machine learning model, the data from the sensor; and
generating, as outputs of the sequence prediction machine learning model, an updated set of preferences of the user representing a set of unspoken needs of the set of needs.

4. The method of claim 3, further comprising:
receiving a user feedback in response to a provided service; and
further training the sequence prediction machine learning model on the user feedback for subsequent identifications of the one or more unmet needs of the user.

5. The method of claim 1, wherein identifying one or more unmet needs among the set of needs comprises:
training a contextual sequence machine learning model on a set of past requests of the user and a set of past request context data;
receiving, as inputs to the contextual sequence machine learning model, the data from the sensor; and
generating, as outputs of the contextual sequence machine learning model, an updated set of requests of the user representing a set of unspoken needs of the set of needs.

6. The method of claim 5, further comprising:
receiving a user feedback in response to a provided service; and
further training the contextual sequence machine learning model on the user feedback, the set of contextual data, or combinations thereof for subsequent identifications of the one or more unmet needs of the user.

7. The method of claim 1, wherein identifying one or more unmet needs among the set of needs comprises:
training a freshness machine learning model on a set of past requests of a plurality of users and a set of contextual data of the plurality of users;
receiving, as inputs to the freshness machine learning model, the data from the sensor; and
generating, as outputs of the freshness machine learning model, a set of requests of the user representing a set of unspoken needs of the set of needs.

8. The method of claim 7, further comprising:
receiving a user feedback in response to a provided service; and
further training the freshness machine learning model on the user feedback for subsequent identifications of the one or more unmet needs of the user.

9. The method of claim 1, wherein identifying one or more unmet needs among the set of needs comprises:
training a predictive machine learning model on a set of preferences of a plurality of users and a set of contextual data of the plurality of users;
receiving, as inputs to the predictive machine learning model, the data from the sensor; and
generating, as outputs of the predictive machine learning model, a set of preferences of the user representing a set of unspoken needs of the set of needs.

10. The method of claim 9, further comprising:
receiving a user feedback in response to a provided service; and
further training the predictive machine learning model on the user feedback, the set of contextual data, or combinations thereof for subsequent identifications of the one or more unmet needs of the user.

11. A system comprising:
one or more processors operable to:
identify one or more unmet needs among a set of needs of a user during a ride of a vehicle based on data from a sensor of the vehicle;
update a user profile of the user to include the one or more unmet needs in association with a set of contextual data related to the ride; and
provide services associated with the one or more unmet needs to the user during another ride based on the updated user profile and the set of contextual data related to the another ride.

12. The system of claim 11, wherein identifying one or more unmet needs among the set of needs comprises:
training a sequence prediction machine learning model on a set of preferences of the user;
receiving, as inputs to the sequence prediction machine learning model, the data from the sensor; and
generating, as outputs of the sequence prediction machine learning model, an updated set of preferences of the user representing a set of unspoken needs of the set of needs.

13. The system of claim 11, wherein identifying one or more unmet needs among the set of needs comprises:
training a contextual sequence machine learning model on a set of past requests of the user and a set of past request context data;
receiving, as inputs to the contextual sequence machine learning model, the data from the sensor; and
generating, as outputs of the contextual sequence machine learning model, an updated set of requests of the user representing a set of unspoken needs of the set of needs.

14. The system of claim 11, wherein identifying one or more unmet needs among the set of needs comprises:
training a freshness machine learning model on a set of personality data of the user and a set of past requests of a plurality of users;
receiving, as inputs to the freshness machine learning model, the data from the sensor; and
generating, as outputs of the freshness machine learning model, a set of requests of the user representing a set of unspoken needs of the set of needs.

15. The system of claim 11, wherein identifying one or more unmet needs among the set of needs comprises:
training a predictive machine learning model on a set of past requests of a plurality of users, a set of past request context data of the plurality of users, or combinations thereof;
receiving, as inputs to the predictive machine learning model, the data from the sensor; and
generating, as outputs of the predictive machine learning model, a set of preferences of the user representing a set of unspoken needs of the set of needs.

16. A non-transitory computer readable medium comprising machine-readable instructions that cause a processor to perform at least the following when executed:
identify one or more unmet needs among a set of needs of a user during a ride of a vehicle based on data from a sensor of the vehicle;
update a user profile of the user to include the one or more unmet needs in association with a set of contextual data related to the ride; and
provide services associated with the one or more unmet needs to the user during another ride based on the updated user profile and the set of contextual data related to the another ride.

17. The non-transitory computer readable medium of claim 16, wherein identifying one or more unmet needs among the set of needs comprises:
training a sequence prediction machine learning model on a set of preferences of the user;
receiving, as inputs to the sequence prediction machine learning model, the data from the sensor; and
generating, as outputs of the sequence prediction machine learning model, an updated set of preferences of the user representing a set of unspoken needs of the set of needs.

18. The non-transitory computer readable medium of claim 16, wherein identifying one or more unmet needs among the set of needs comprises:
training a contextual sequence machine learning model on a set of past requests of the user and a set of past request context data;
receiving, as inputs to the contextual sequence machine learning model, the data from the sensor; and
generating, as outputs of the contextual sequence machine learning model, an updated set of requests of the user representing a set of unspoken needs of the set of needs.

19. The non-transitory computer readable medium of claim 16, wherein identifying one or more unmet needs among the set of needs comprises:
training a freshness machine learning model on a set of personality data of the user and a set of past requests of a plurality of users;
receiving, as inputs to the freshness machine learning model, the data from the sensor; and
generating, as outputs of the freshness machine learning model, a set of requests of the user representing a set of unspoken needs of the set of needs.

20. The non-transitory computer readable medium of claim 16, wherein identifying one or more unmet needs among the set of needs comprises:
training a predictive machine learning model on a set of past requests of a plurality of users, a set of past request context data of the plurality of users, or combinations thereof;
receiving, as inputs to the predictive machine learning model, the data from the sensor; and
generating, as outputs of the predictive machine learning model, a set of preferences of the user representing a set of unspoken needs of the set of needs.
